(19) United States
(12) Patent Application Publication
(10) Pub. No.: US 2023/0282068 A1
(43) Pub. Date: Sep. 7, 2023

(54) GAMING MACHINE AND METHOD OF OPERATION THEREOF

(71) Applicant: Aries Technology LLC, Las Vegas, NV (US)

(72) Inventors: Ronnie W. Harris, Las Vegas, NV (US); David B. Schultz, Las Vegas, NV (US); Jason Cole, Las Vegas, NV (US)

(21) Appl. No.: 18/116,193

(22) Filed: Mar. 1, 2023

Related U.S. Application Data
(60) Provisional application No. 63/315,876, filed on Mar. 2, 2022.

(51) Int. Cl. G07F 17/32

(52) U.S. Cl. CPC G07F 17/3267; G07F 17/3211; G07F 17/3216

(57) ABSTRACT

A gaming device may present a game object-based wagering game or promotional event. Game objects, including play and prize objects, may be associated with one or more play surfaces, with an object to move them to a collection area. Collected objects may result in the award of prizes. The gaming device may also be configured to present a wagering game, where play of the object-based game may be triggered from play of the wagering game.

### RELATED APPLICATION DATA

The present invention application claims priority to U.S. Provisional Application Serial No. 63/315,876, filed Mar. 2, 2022, which application is incorporated by reference in its entirety herein.

### FIELD OF THE INVENTION

The present invention relates to gaming machines or devices, including such machines which are configured to present wagering games.

### BACKGROUND OF THE INVENTION

A multitude of gaming machines are known for presenting wager-based games. For example, these gaming machines include traditional mechanical rotating-reel games known as “slot machines”, and newer video-style gaming machines which present similar games (e.g. emulate reel spins graphically) or present a variety of other games, such as video poker, video blackjack and the like.

However, players continually seek new and exciting wagering games. There are many popular skill-based games, such as various video amusement games (e.g. PacMan™, Centipede™, Mario Kart™, Fortnite™, etc.) and the like. There are also many popular games that are generally known as traditional amusement games, such as Skee-ball, crane games and the like. Given the familiarity of players with those games and the popularity of those games to players, there is a desire to present those or similar games to players in a wagering format. However, converting those skill or amusement games into wagering games has proven to be very difficult. As a result, skill-based games have yet to make a substantial impact on the wager-based gaming market.

In particular, a whole host of problems arise when attempting to implement skill-based games, traditional amusement games and the like, as wagering games. Among other things, the highly regulated nature of wager-based gaming machines means that existing skill-based games and amusement type games are non-compliant. These regulations generally require a high level of security, redundancy and verification. In addition, to be approved, wagering games must have a verifiable expected result.

An improved gaming machine is desired.

### SUMMARY OF THE INVENTION

Aspects of the invention comprise gaming machines, features of gaming machines, methods of presenting and playing games, including in wagering formats, and methods of presenting and playing promotional events.

In one embodiment, a gaming machine comprises a play surface on which a plurality of game objects are supported, a game object mover configured to engage one or more of the plurality of game objects on the play surface, whereby one or more of the plurality of game objects may move over a ledge of the play surface and fall into a collection area and at least one transport mechanism configured to move the game objects which fall into the collection area back to the play surface at one or more times.

In another embodiment, the gaming machine comprises a housing; an movable object type amusement game device comprising: a play surface on which a plurality of game objects are supported, a game object mover configured to engage one or more of the plurality of game objects on the play surface, whereby one or more of the plurality of game objects may move over a ledge of the play surface and fall into a collection area, and at least one transport mechanism configured to move the game objects which fall into the collection area back to the play surface at one or more times; at least one display device; a monetary-value receiving device for creating a monetary value credit balance at the gaming machine; and a processor, the processor configured to execute machine-readable code stored in memory to: present at least one wagering game to the player in response to a wager placed from the monetary value credit balance, comprising presenting wagering game information on the display device, determine an outcome of the wagering game and award winnings for winning outcomes of the wagering game, and activate the amusement game device for play by the player one or more times.

Further objects, features, and advantages of the present invention over the prior art will become apparent from the detailed description of the drawings which follows, when considered with the attached figures.

### DESCRIPTION OF THE DRAWINGS

FIGS. 1-3 illustrate aspects of a configuration of a gaming machine in accordance with an embodiment of the invention;

FIG. 4 schematically illustrates aspects of mechanisms of the gaming machine illustrated in FIGS. 1-3; and

FIG. 5 illustrates aspects of another embodiment of a gaming machine in accordance with the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Aspects of the invention comprise gaming machines, features of gaming machines, methods of presenting and playing games, including in wagering formats, and methods of presenting and playing promotional events.

### Overview of Gaming Machine

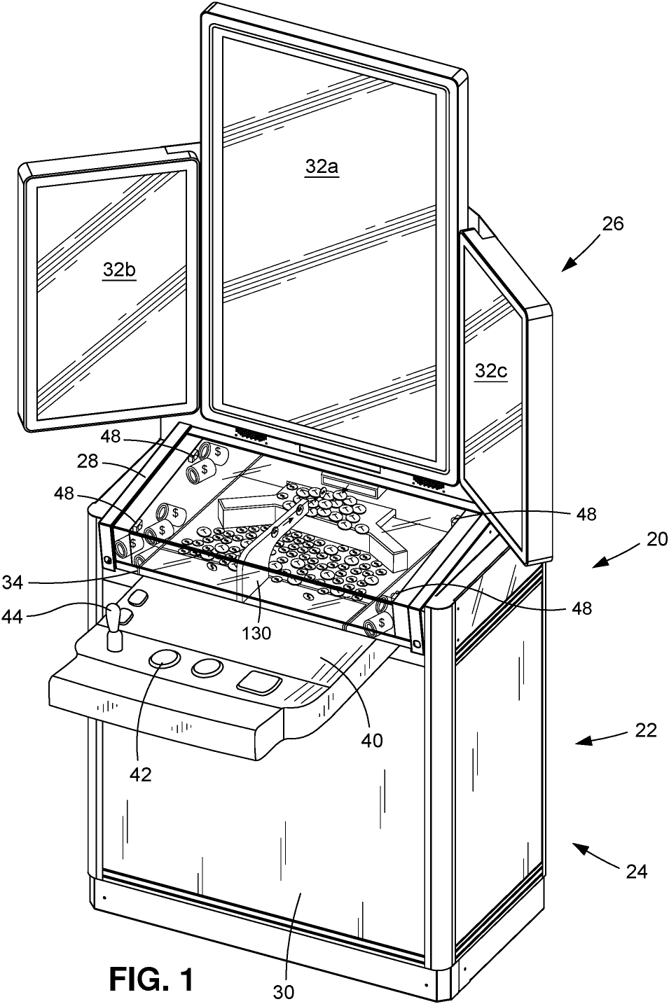

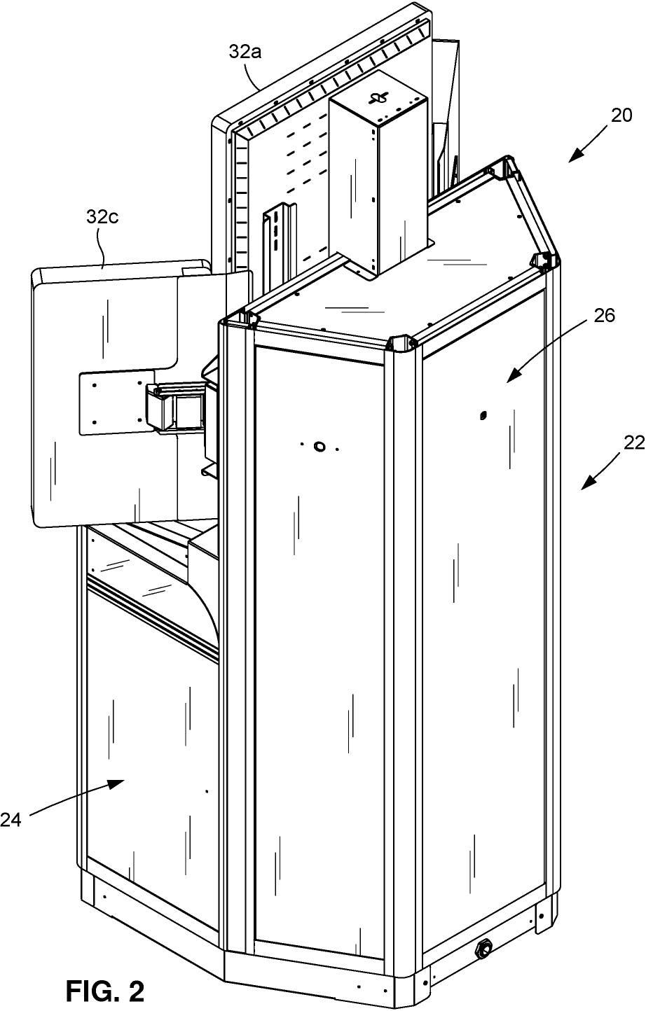

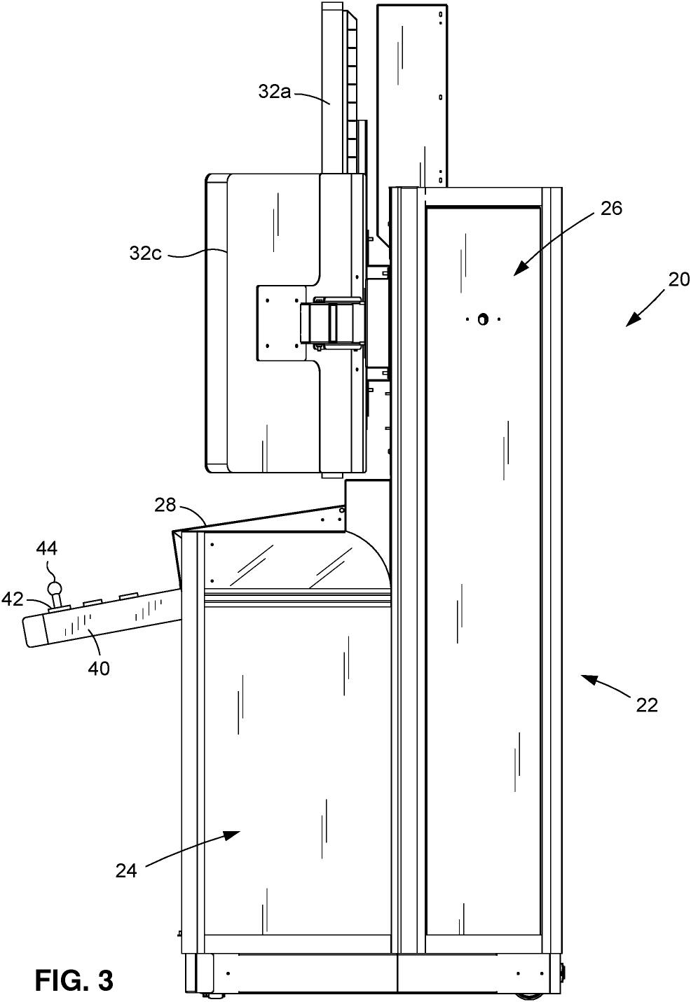

FIGS. 1-3 illustrate one example of a gaming machine or device 20 in accordance with the invention. The gaming machine 20 may include a housing 22 for supporting and/or containing one or more components thereof. In one configuration, the housing 22 generally has a lower portion 24 and an upper portion 26. In general, the housing 22 has a front, a rear and two sides. The gaming machine 20 is designed so that a player of the gaming machine 20 faces the front thereof when playing the machine.

The lower portion 24 may define an interior or internal area for housing various components. In one embodiment, the lower portion 24 defines a top 28. The top 28 is preferably generally planar or horizonal. The top 28 may be about 30-40 inches above a bottom of the gaming machine 20 and a supporting surface upon which it rests.

One or more doors or panels may be provided that can be moved between open and closed positions for controlling access to the interior of the housing 22. For example, a main door 30 may be provided at the front of the lower portion 26 for controlling access thereto. The main door 30 may be movably mounted, such as via hinges. One or more locks, intrusion sensors and the like may be provided for controlling and monitoring use of the door 30.

The upper portion 26 of the housing 22 may extend upwardly from the lower portion 24, such as generally at the rear of the gaming machine 20. The upper portion 26 may support one or more display devices, such as one more video displays 32a,b,c. In this embodiment, three video displays 32a,b,c are provided, though in other configurations, as few as one and more than three video displays might be provided. The video displays 32a,b,c may be of various types, such as LCD, OLED, etc. Also, in other embodiments, other types of displays might be used. For example, the displays might comprise rotating reels.

In the configuration illustrated, a central video display 32a is provided, along with two side displays 32b,c on either side thereof. In other configurations, the video displays might be stacked, such as with a main display and then a top display mounted above the main display. The displays 32a,b,c may be supported by the upper housing 26 by various mounts, including one or more mounts which permit a position of the display to be varied (such as permitting the angle of the side displays to be adjusted; the height of the displays to be changed, etc.). As another example, a single display 32 might be provided, such as a large curved screen display.

In one configuration, a play area 34 is defined by the lower housing 26, wherein a top of the play area may be defined by the generally planar top 28 thereof (though it might angle slightly, such as downwardly towards the player). In order to permit a player to see into the play area 34, at least a portion of the planar top 28 may be transparent, such as being constructed from glass. In the illustrated configuration, both a portion of the top and a portion of the front of the lower portion 24 of the housing 22 are transparent.

In this configuration, the displays 32a,b,c are located above, and generally behind, the play area 34. In this configuration, a player sitting or standing can see downwardly into the play area 34, while at the same time see information presented by the displays 32a,b,c in front of them - and in a preferred embodiment, have the displays 32a,b,c located within arm’s reach for engaging the displays (such as touch screens associated therewith).

The gaming machine 20 may have other configurations. In one example, the gaming machine 20 is configured to present one or more wagering games and/or one or more promotional games or events, as described in more detail below.

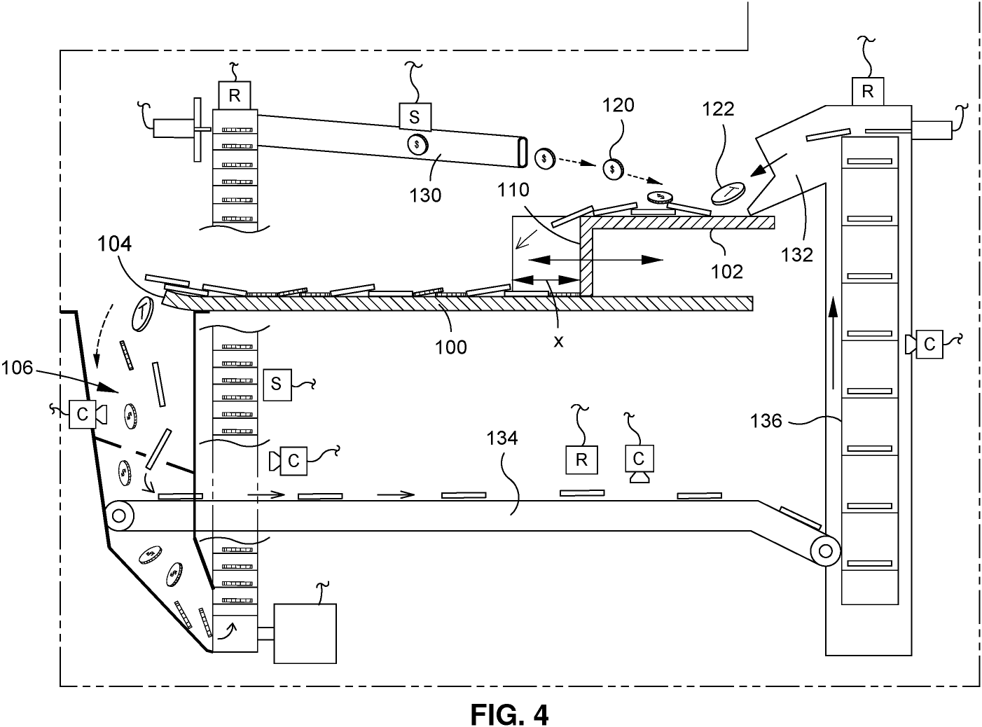

In one example, the gaming machine 20 may include or be configured to present one or more games which include the use of game objects, including where the location of those objects may change. As one example, as illustrated in FIG. 4, the play area 34 may include or contain at least one play surface, wherein one or more game objects may be located on or be supported by the play surface.

In the illustrated example, the gaming machine 20 include at least one main play surface 100. The gaming machine 20 may further include at least one second play surface 102, which surface is raised in this embodiment. In this example, the raised play surface 102 is movable relative to the main play surface 100. When the main play surface 100 is generally quadrilateral in shape, it may have a front, a rear and a pair of sides. However, the main play surface 100 might have other shapes.

In the illustrated example, the raised play surface 102 is generally located at the rear of the main play surface 100. The front of the main play surface 100 may comprise a ledge 104 which is elevated, such as above a collection area 106. The ledge 104 may be generally horizontal or, as illustrated angle upwardly (or have other configurations as noted below). In this regard, in one configuration, the main play surface 100 comprises a surface from which game objects may move to a game determinant location, which location may comprise the collection area 106. Other play surfaces, such as the raised play surface 102, may support game objects, such as for movement to the main play surface 100 (and where, generally, movement of game objects from those other play surfaces is not to a game determinant location).

One or more means may be provided for moving the game objects, and particularly those game objects on the main play surface 100. The game object movers may have various configurations, such as comprising reciprocating pushers or other elements, as described in more detail below.

In one configuration, the object mover comprises a portion of the raised play surface 102. In one configuration, the raised play surface 102 has a face 110, and the raised play surface 102 is movable. The raised play surface 102 may be movable in various manners, such as reciprocating back and forth towards and away from the front of the main play surface 100 (such as by one or more motors). The face 110 may have various configurations (shapes, angles, etc.), as detailed herein. The raised play surface 102 is located at an elevation above the main play surface 100 and may have a different shape and/or size that the main play surface 100.

In general, game objects may be located on the main play surface 100 and/or the raised play surface 102. The game objects may, in one configuration, comprise play objects 120 and prize objects 122. The play objects 120 and prize objects 122 may be of various types, including different sizes, shapes, materials, markings, etc. In one example, the play objects 120 are coins or coin-like, and the prize objects 122 are chips or tokens. Additional details of the play objects 120 and prize objects 122 are provided below.

The gaming machine 20 may include means for associating the game objects with the play area, such as the main play surface 100 and/or raised play surface 102. In one example, game objects may be delivered to the play area 34, such as the raised play surface 102. This delivery mechanism may comprise a launcher 130. The launcher 130 may be configured to release or launch one or more game objects, and preferably play objects 120, to the play area. In the preferred configuration, the play objects 120 are launched onto the raised play surface 102. As described in more detail, those play objects 120 may move (such as fall or drop) from the raised play surface 102 to the main play surface 100. As also described in more detail below, the play objects 120 may ultimately fall off of the front of the main play surface 100 at the ledge 104 and then fall into the collection area 106.

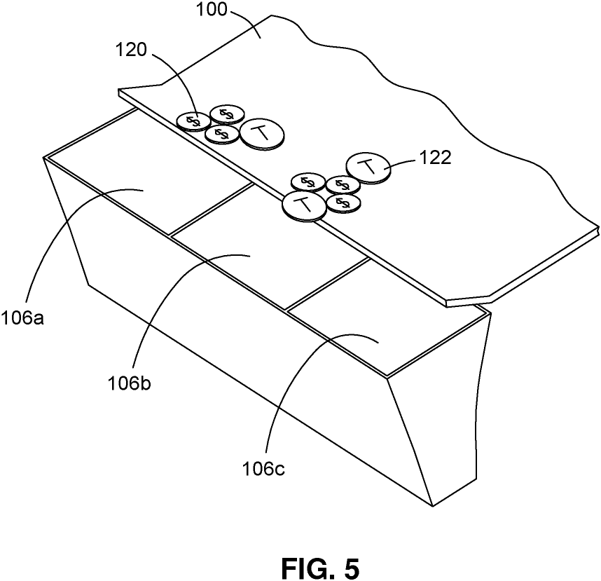

In some embodiments, such as illustrated in FIG. 5, more than one collection area may be provided. For example, different collection areas 106a, 106b and 106c might be provided (of course other numbers of collection areas might be utilized). In this embodiment, the collection areas 106a,b,c are located at different positions below the ledge 104, such as along the width thereof. As described below, the collection of game objects into the different collection areas 106a,b,c might result in different outcomes, trigger different events and the like.

In one configuration, collected game objects are returned or recycled back to the play surface(s) at one or more times. The prize and play objects might be returned or recycled back to the play surface(s) by a common delivery mechanism. However, in a preferred embodiment, the prize and play objects are returned or recycled back to the play surface(s) by different mechanisms.

In the illustrated example, collected play objects 120 may be recycled back to the play surface(s), such as by a first delivery mechanism. This may comprise a track, elevator or similar mechanism which feeds play objects to the launcher 130 (including moving or raising them upwardly from a first elevation, such as from the object collection area 106 to the launcher 130).

Likewise, a second mechanism may be provided for delivering prize objects 122 to the play area 34, such as onto one of the play surfaces. In this example, prize objects 122 are also delivered to the raised play surface 102, such as from a second delivery device, such as a prize object drop or release mechanism 132. Again, the prize objects 122 may travel from the raised play surface 102 to the main play surface 100, and thereon off the ledge 104 and into the collection area 106.

The prize objects 102 may be delivered by a conveyor 134 or similar mechanism to an elevator 136 which raises them upwardly.

In one example a sorter is provided for separating the play objects 120 from the prize objects 122 which fall into the collection area 106, whereby only play objects 120 are delivered to the first launcher 130 and only prize objects 122 are delivered to the drop/release mechanism 132. As described below, more than one sorter, or sorters of different types, might be provided for separating objects of different types, such as for use in routing the game objects to different locations (such as to different play surfaces, to a prize dispenser, etc.), for use in tracking or counting the objects, etc.

In one embodiment, as described below, an object of a game played in the play area 34 is to move game objects from the one or more play surfaces to the collection area 106.

As described in more detail below, one or more controllers are utilized to control the operation of the gaming machine 20. The controller may comprise a processor which is configured to execute machine-readable code stored in a memory. The controller may also include at least one communication interface, which interface may include a bus for internal communications with the memory and associated devices of the gaming machine 20, and a second communication interface for communication with external devices and/or systems.

As detailed below, the gaming machine 20 may include various other features, including relating to operation and security thereof. As one example, as illustrated in FIG. 1 and described in more detail below, the gaming machine 20 may include one or more image capture devices 48, such as cameras. The cameras might be used to capture information regarding game play, and also one or more images of the player (for use in game play, security and other purposes).

For example, the gaming machine 20 is preferably configured to accept wagers, and may thus include at least one means for accepting monetary value. This might comprise a coin acceptor, bill validator, media reader for reading tickets, cards or the like, and/or other interfaces, such as for mobile payment, monetary value transfer or the like. The monetary value acceptor may communicate with the controller which creates and maintains a credit balance, such as of monetary value - which may be in the form of a number of credits having associated monetary value.

The gaming machine 20 may also include a player tracking device, such as a card reader or player input device for accepting identifying information (player tracking account number, ID number, PIN, etc.).

As illustrated, the housing 22 may include a console or deck 40, such as which extends outwardly from the front of the housing 22 towards the player. The gaming machine 20 may include one or more player input devices, such as for allowing the player to provide input thereto associated with game initiation, game play, cash-out, etc. The player input devices may include touch-screens which are associated with one or more of the video displays 32a,b,c. One or more player input devices might also be associated with the console 40. For example, one or more buttons 42, a joystick 44 or other input devices may be provided (touch pads, keys, etc.).

The gaming machine 20 may also be configured to award prizes or awards. For example, the gaming machine 20 may award winnings in the form of one or more credits. The credits may or may not have monetary value, and they might be cashed out (disassociated from the gaming machine 20), such as by transfer, printing of a ticket, via a card, etc.

In one configuration, the gaming machine 20 may be configured to present one or more wagering games via the one or more video displays 32a,b,c. Such games might comprise, for example, video poker games, slot-style games, bingo games or other games now known or later developed. The gaming machine 20 may also present one or more games in the play area 34. In another embodiment, the gaming machine 20 may present a wagering game via the one or more displays, which game may include or trigger a play of a game in the play area 34. In other embodiments, the game which is presented in the play area 34 may comprise a promotional game or event.

In one configuration, the game which is presented in the play area 34 may be referred to as an “object” game or event, in that the play and outcome thereof is determined by the use of the game objects referred to above. The outcome of such a game may be determined with reference to the game objects which are moved from the play surfaces to the collection area 106. For example, prize objects 122 which are moved from the play surfaces to the collection area 106 may result in the award of one or more prizes to the player. In some instances, play objects 120 which are moved from the play surfaces to the collection area 106 may also result in the award of one or more prizes to the player, although a primary mechanism of the play objects 120 is to move the prize objects 122 across the play surface(s) to the collection area 106 (in particular, as play objects 120 are added to the play surface(s) at locations behind the front ledge 104, those objects occupy space which tends to cause other play objects or prize objects, to fall into the collection area -particularly in response to movement of object movers as detailed below). Additional details and aspects of the presentation of games and promotions are provided below.

### Main Game

As indicated above, the gaming machine 20 may be configured to present a main game, which game may be wager-based. The main game may be presented with reference to game information displayed on the one or more video displays 32a,b,c. In one embodiment, a player may place a wager, such as from a credit balance associated with the gaming machine 20, either automatically triggering or allowing the player to initiate, a main wagering game. The main wagering game may be any of a variety of games now known or later developed. For example, the main wagering game may be what are known as Class II or Class III games, such as bingo games, bingo-based games, slot-type games, poker, blackjack or other games. In one embodiment, the presentation of the game includes the display of game information to the player via one or more of the displays 32a,b,c. The main game may have a number of outcomes, one or more of which, but preferably not all, are winning (the remaining outcomes may be losing). Winning outcomes may have an associated award, such as the award of monetary value credits to the player (which may be associated with the credit balance of the player). In some instances, as detailed herein, outcomes or events associated with the main game may trigger the operation or play of an object-based game associated with the play area 34.

### Object Game Features

Basic aspects of features of the gaming machine 20 have been described above for reference. It will be appreciated that the configuration of these features may vary and./or other features may be provided. In particular, variations in the features may be used to change the probabilities of outcomes of the object game (e.g. win/loss probability, volatility of wins/losses, etc.) and add to player anticipation or excitement. As described below, variations in the features of the game may also impact the strategy of the player in playing the game.

### Game Objects

As indicated above, the game objects may have various shapes, sizes, colors, masses, markings, surface features including coefficients of friction, and/or other characteristics. In some embodiments, the game objects are coin-like or coin shaped and may be made of metal. However, the game objects might be made of plastic or other polymers, glass, wood, etc.

The game objects might comprise spherical objects (marbles, etc.) or have other shapes.

The game objects may be of differing colors or have different markings. In some embodiments, the game objects may illuminate different colors or light in different patterns, such as to distinguish them. As one example, as described below, a “hot” object might be provided, such as which is associated with a large prize or a prize that is only active at certain times. In one embodiment, the object may be illuminated to indicate it’s “hot” or “active” status. In other embodiments, the game objects might be luminous (glow), fluoresce (such as in response to UV light/black light), etc. As described in more detail below, a game object may even include a display which allows the game object to display different information at different times (e.g. be “configurable”).

As indicated above, in one embodiment of the invention, the game objects comprise at least two different types of objects - e.g. that are distinguishable from one another by the player. Such objects may comprise the play objects 120 and the prize objects 122.

In one embodiment, the play objects 120 might be coin-like, such as being coin-sized and being made of a metal or metal alloy. The prize objects 122 may be configured as tokens, and may be made of a different material, such as being made of clay, plastic or ceramic.

Further, the play objects 120 and the prize objects 122 might be distinguishable in other manners, such as by color or marking. Further, different prize objects 122 might be distinguishable from others, such as by markings. For example, at least one prize object 122 might be marked with the symbol $, and have a first associated characteristic (such as value) and at least one other prize object 122 might be marked with a $$ symbol, and have a second associate characteristic (such as a higher value).

In one embodiment, RFID tags or other identification tags or elements (visible or invisible bar or other readable codes, magnetic stripes or other coding) may be associated with the game objects, such as at least the prize objects 122.

In some embodiments, different mixtures of game objects may be utilized. For example, disc (coin/token) type game objects might be used primarily, but at certain times special game objects might be introduced. For example, a player might be permitted to launch a marble-shaped game object onto the main play surface 100 or the secondary/raised play surface 102 (thus causing the other game objects to move, such as to cause some of them to fall off of the main play surface 100 into the collection area 106).

In one embodiment, one or more game objects, and preferably at least the prize objects 122, are both uniquely identifiable and have at least one associated secondary attribute, such as a value, prize or secondary feature (such as described below, an associated slot symbol, playing card, puzzle piece, etc.). The associated secondary attribute may vary, such as based upon the gaming machine 20 with which it is associated and/or the wager amount or prize table for the game. In one embodiment, the secondary value is changeable. For example, prize object #14545 may have a secondary attribute of a value of $50 when associated with a gaming machine 20 that requires a $5 wager, but only a value of $25 when associated with a gaming machine that requires a $1 wager.

### Play Surfaces and Object Movers Generally

In general, while the figures illustrate an object game device for presenting an object-type or object-based game. The object game device may have a main play surface 100 and a raised play surface 102 which also serves as an object mover, the object game might have other configurations. For example, the object game might have a single play surface. It might also have more than two play surfaces, including more than one main play surface and/or more than one secondary play surface, where the secondary surface(s) may or may not be raised (and may be raised at one or more different elevations).

Also, game object movers may be integrated into or comprise secondary or raised play surfaces, but might also be entirely separate therefrom. The number of game object movers may also vary, as may their type and operation. For example, game object movers may have different shapes, different speed of movement, different distance of movement, different path of movement, etc. Further, while game object movers might move relative to a play surface, the game object mover might be configured to move a play surface (raise, shake, etc. that surface).

### Object Mover

As indicated above, the configuration of the object mover(s) may vary, including in shape and manner of movement. As one example, the distance of travel of the object mover may vary or be varied. As one example, where the object mover comprises the movable raised play surface 102, that raised play surface may reciprocate back and forth relative to the main play surface 100 by the distance X (as illustrated in FIG. 4). In one aspects of the invention, the movement of the raised play surface 102 is controlled, and may be altered and/or adjusted, including at different times. As one example, shorter pushes increases number of game objects on the main play surface 100 to reach the equilibrium for that length of push, while longer pushes allow for fewer game objects on the main play surface 100 to reach the equilibrium for that length of push. Increasing the length of the push after a series of short pushes will then force the main play surface 100 back to the equilibrium for the now shorter main play surface space, pushing that many game objects off of it with one or more push, creating a wave of game objects into the collection area 106 that creates player anticipation and excitement. This “the big wave” or “the big push” could be a bonus feature, a persistence feature, or an in-game trigger feature. Of course, this feature may be applied to game object movers that do not comprise raised or secondary play surfaces 102. The movement may be in a front/back direction, left/right direction and/or other directions.

As indicated, the game object mover might comprise a vibration feature (or up/down movement, etc.). For example, the main play surface 100 and/or the raised play surface 102 might be vibrated. A vibration mode may help dislodge game objects that are close to falling off so that they fall off onto the main play surface, or from the main play surface to the collection area 106. The vibration mode might be implemented at different times, such as based upon triggering events, or be awarded to players who may initiate the mode. As one example, vibration modes may have different amplitudes, such as a “small quake” or “big quake.”

The game object mover(s) might comprise other features or elements. This might comprise one or more of:

(1) Tombstones. Portions of the main play surface 100 or raised play surface 102 may pop-up or raised up to push game objects in various directions (such a forward, upwardly, etc.). These tombstones may stay in their raised position to block game objects from moving forward, or be moved to their retracted/closed position at other times.

(2) Periscope Runners. Elements may be extended outwardly from the main play surface 100 or the raised play surface 102 to move objects. For example, periscope type elements may pop-up or be raised and then also move or extends in various directions and distances along the main play surface 100 and/or raised play surface 102 (and may move in straight lines, randomly, in circles, etc.) to encounter and move game objects on those surfaces. The periscope features may be retracted at various times.

(3) Flippers. Flippers may be provided at various locations relative to the main play surface 100 and/or raised play surface 102. Such flippers may comprise movable bodies which can push game objects (such as forward, backward, to the side, center or in a circle). The flippers can be submerged and pop up and down on the play surface(s) or be mounted in a stationary position on the play surface(s).

(4) Joisting Poles. Extensions may be moved towards the play surfaces, and the game objects thereon. These extension might be pole or rod shaped, or have other shapes. They may have different shaped heads, such as for contacting or engaging the game objects in different manners.

Some of the object movers might be strategically placed. For example, one or more flippers might be placed in locations where game objects stall or become bottlenecked, thus allowing the player to move the game objects in certain areas at one or more times.

The object movers might also comprise claws, cranes, magnets or other elements for picking up game objects and moving them, such as to a different location, including to the collection area 106.

In some embodiments, the object movers might be associated with one or more individual game objects. For example, small electronic elements might be located in certain game objects that, when activated, cause the elements, and thus the game objects, to vibrate. In others, the game objects might have certain characteristics which causes them to move - such an internal device which, when exposed to a certain emitted wave frequency or other trigger, causes the object to vibrate.

The game object movers may be moved in various manners. For example, game object movers may be moved randomly, in a fixed pattern, or based upon a particular triggering event. In other embodiments, the game object movers might be activated by a player or might be moved (e.g. flippers) by the player, such as based upon player input.

As indicated above, one or more object movers may be utilized to move game objects on the one or more play surfaces. In some embodiments, the object movers may only operate during play of the gaming machine 20, such as starting after a player has associated monetary value with the gaming machine 20, placed one or more wagers, and/or engaged in other game-related activities. If the gaming machine 20 is inactive for a period of time, has no credits associated therewith, or the like, the object movers may be moved into inactive mode. In one embodiment, in such situations the one or more objects movers might be moved into an “attract mode”, wherein they still move, but may move with less amplitude or the like, so that they are visibly moving, but limiting the potential for the movement of objects to the collection area 106. As one example, in the case of a reciprocating raised play surface 102 that normally moves back and forth a distance X, that distance may be changed to X/2, or some other value less than X, whereby the raised play surface 102 still moves, but generally does not engage game objects on the main play surface 100.

### Secondary or Raised Play Surface

The shape, size, height or other characteristics of the raised play surface 102 (or other secondary play surface(s)) may be varied to change the characteristics of the object game.

Raised play surface angle: while the raised play surface 102 may be generally horizontal, it could have other configurations, such as being angled (including relative to the main play surface 100). The raised play surface 102 may be generally parallel to the main play surface 100. This allows for a set number of game objects to reach a certain equilibrium which can be altered by the skill level of player that can control the game object drop location. A backward pitch (slope) of the raised play surface 102 will increase the number of game objects needed to reach equilibrium for that service space A forward pitch (slope) of the raised play surface 102 will decrease the number of game objects needed to reach equilibrium for that service space.

The raised play surface 102 may also have different elevations and/or slopes. Sloping one side of the raised play surface 102 higher than the other will cause game objects to slide to the lower side, depending on the pitch. In another configuration, both ends of the raised play surface may be higher than a center, resulting in game objects sliding to the center of the raised play surface. In another configuration, the center of the raised play surface 102 may be higher than the sides.

In one configuration, the pitch of the raised play surface 102 may change at one or more times, such as during game play - thus greatly increasing the volatility of the number of game objects entering the main play surface 100, and thus impacting player strategy and skill (when to use play objects and where to place play objects), and larger the number of game objects entering the main play surface 100 from the pitch changes will increase player anticipation and excitement as larger number game objects are pushed off the ledge 104 and into the collection area 106.

The overall shape of the raised play surface 102 (including the face 110 thereof) may vary. In one configuration, a middle portion may extend outwardly (towards the main play surface 100 and the front of the gaming machine 20) further than the sides (such as to form a wedge), thus pushing into game objects on the main play surface 100 differently (than if the face 110 is planar).

Alternatively, one or both sides of the raised play surface 102, or at least the face 110, may extend outwardly further than the center, again altering interaction with the game objects on the main play surface 100.

In one embodiment, a wall or ledge may be located at the front of the raised play surface 102. This keeps more game objects on the raised play surface 102 (like a dam). These game objects, when released, cause a big wave of game objects to fall off the raised play surface 102 onto the main play surface 100, thus creating a wave of game objects falling off of the ledge 104 into the collection area 106. In some embodiments, the wall or ledge may prevent game objects, and particularly play objects 120 which are being directed towards the raised play surface 102 (such as from the first launcher 130) to be blocked and thus be directed to the main play surface 100. The wall or ledge might be moved up and down at different times, such as during bonus events or for other reasons. As indicated, for example, the wall or ledge might be raised at certain times to “dam” the game objects, and then the wall or ledge might be lowered at other times, thus releasing a quantity of game objects.

In one configuration, the raised play surface 102 may be split in multiple sections (e.g. such as by having more than one such raised play surface). In such a configuration, each raised play surface 102 may have different characteristics (such as those variations noted above), including where each raised play surface 102 is movable relative to the others (different distances, speeds, etc.).

### Main Play Surface

As with the secondary or raised play surface(s) 102, the shape, size, height or other characteristics of the main play surface 100 may be varied to change the characteristics of the object game.

Raised play surface angle: while the main play surface 100 may be generally horizontal, it could have other configurations, such as being angled. The main play surface 100 may be generally parallel to horizontal and/or the raised play surface 102. This allows for a set number of game objects to reach a certain equilibrium which can be altered by the skill level of player that can control the game object drop location. A backward pitch (slope) of the main play surface 100 will increase the number of game objects needed to reach equilibrium for that service space. A forward pitch (slope) of the main play surface 100 will decrease the number of game objects needed to reach equilibrium for that service space.

The main play surface 100 may also have different elevations and/or slopes. Sloping one side of the main play surface 100 higher than the other will cause game objects to slide to the lower side, depending on the pitch. In another configuration, both ends of the main play surface may be higher than a center portion, resulting in game objects sliding to the center of the main play surface. In another configuration, the center of the main play surface 100 may be higher than the sides.

In one configuration, the pitch of the main play surface 100 may change at one or more times, such as during game play - thus greatly increasing the volatility of the number of game objects moving to the collection area 106, and thus impacting player strategy and skill (when to use play objects and where to place play objects).

The overall shape of the main play surface 100 may vary. In one configuration, a middle portion may extend outwardly further than the sides (such as to form a wedge). Alternatively, one or both sides of the main play surface 100 may extend outwardly further than the center.

In one embodiment, the ledge 104 at the front of the main play surface 100 may be movable, such as to change the angle thereof (horizontal, upward pitch or downward pitch). In other embodiments, the main play surface 100 might include a dam, such as a raisable/lowerable stop element, such as near the ledge 104 or elsewhere.

In one configuration, the main play surface 100 may be split in multiple sections (e.g. such as by having more than one such main play surface). In such a configuration, each main play surface 100 may have different characteristics (such as those variations noted above).

### Object Launchers/Dispensers

As indicated, means are preferably provided for associating game objects with the play area, and namely the play surfaces. As indicated above, in one embodiment, game objects are moved from the play surfaces to a collection area 106. Eventually, this would result in inaction in the game due to there being no movement of game objects or no remaining game objects associated with the play surfaces. As a result, the gaming machine 20 preferably includes one or mechanisms for moving game objects to the play surface(s).

As indicated above, such a mechanism may comprise a launcher 130, such as which launches one or more game objects, such as in the direction of the play surfaces. However, other mechanisms may be provided. These may comprise a crane, claw or magnet that can be used to pick up and move one or more game objects. While “gravity” based object launchers are known (such as elongate tracks that allow the object to drop and they be projected to a play area), such mechanisms are generally incompatible with the gaming machine 20 as described herein, particularly, when the play surface is not very tall (having a low horizontal top), since no room then exists for such a mechanism. Thus, the object launcher is preferably uniquely configured to fit within the low profile play area 34 or under or behind the play area. The launcher 130 described above has such an advantage because mechanical force is used to expel the one or more game objects, such as from a generally low-profile launcher.

As indicated, the mechanism might also comprise an elevator and a drop or release mechanism (where again, the elevator is located under and/or behind the play area 34 and the game objects, such as prize objects 122, may simply be dropped a short distance onto the raised play surface 102).

The mechanism may be configured to launch or move one game object at a time, multiple game objects at the same time, or a succession of game objects.

The mechanism may be configured to move game objects to the same or different locations, including at the same or different times.

The mechanism may be configured to move just play objects, just prize objects or both.

As indicated, multiple game object launchers may be provided.

As with the game object movers, the launchers may be operated or controlled in various manners, including by the controller of the gaming machine 20 (such as randomly, based upon triggering events, etc.) or based upon player initiation or control. For example, a player may receive different awards to allow one, two or more launchers to be activated or operated by the player. For example, certain awards or triggers might allow a player to activate or operate a first launcher that directs game objects, such as play objects, to a secondary or raised play surface 102, and others might allow a player to activate or operate a second launcher that directs game objects, such as play objects, to the main play surface 100.

As indicated above, in a preferred embodiment, different mechanisms are used to deliver play objects 120 and prize objects 122 to the play surface(s). In one configuration, prize objects 122 are launched (released, dropped, etc.) only under the control of the controller of the gaming machine controller (and not at the direction or control of the player) while play objects may be launched or released by the controller and/or a player.

### Related Operational and Security Features

The gaming machine 20 may include various other feature or elements, such as for operating the one or more games or promotional elements (including the object game/event and/or other games, such as video-based wagering games), for security and other purposes.

As one example, means may be provided for identifying the game objects. For example, means may be provided for identifying the prize objects 122. When the prize objects 122 include an RFID or other tag, the means may comprise an RFID reader. As illustrated in FIG. 4, multiple readers may be provided at different locations, so as to read the prize objects 122 in different locations. As one example, the prize objects 122 might be read or identified at the collection area 106, the conveyor 134 and the elevator 136). Of course, other means might be used to identify the objects, such as bar code scanners, weighing devices, cameras, etc. (depending upon the distinguishing features of the objects).

In some embodiments, means may be used to count or track the game objects. For example, play objects 120 might simply be counted, such as when they drop to the collection area 106.

In general, multiple counters or other sensors S are provided, such as at different locations, in order to provide redundancy to the counting and tracking process. As described in more detail below, such is important in ensuring that game is operating correctly. This redundancy may apply to sorters, transporters, launchers, etc., to ensure the proper operation thereof.

In that the gaming machine 20 is configured to present games or events as wagering games or events, it is desirable (and generally required by regulation) that the gaming machine 20, and the operation thereof, be secure (e.g. highly tamperproof). Unlike traditional wagering game machines which do not utilize movable game objects, the use of movable/moving game objects in this instance requires unique security features.

In one embodiment, one or more cameras may be associated with the play area 34. For example, multiple cameras may be located in or be directed to capture image information from within the play area 34. This information may be stored, such as for game play verification purposes (including to validate (or invalidate) wins, confirm malfunctions, etc.). In one configuration, where the play area 34 is generally quadrilateral in shape, a camera is located at each corner of the play area 34.

In one embodiment, one or more tilt or movement sensors may be associated with the gaming machine 20. Tilt sensors might be associated with the gaming machine 20, such as the housing 22, to detect vibration or movement of the gaming machine 20, large sounds, etc., such as might be caused by a player attempting to move the game objects. In some embodiments, triggering of a tilt sensor may cause the controller to lock the gaming machine 20 from play, to prevent any game objects that fall into the collection area 106 from the main play surface 100 from being attributed to the player, and may cause the gaming machine 20 (such as the video displays 23a,b,c) to display a warning or other notification (for example, in the event of a detected tilt, a visible and/or audible warning may be provided to the player, such as indicating that a tilt has been detected and that any objects collected from that point are invalid). In some embodiments, the one or more cameras may be used to capture the event, including an image of the player for storage and/or display on the displays (or external displays or security systems, etc.).

As another example, level or gyroscopic sensors might be used to ensure that the gaming machine 20 remains level (e.g. is not tilted by raising it up and down, etc.), thus impacting the operation thereof. Again, triggering of such a sensor may cause the controller to lock the gaming machine 20, etc., as noted above.

In one configuration, components of the gaming machine 20 may be segregated for security purposes. As one example, the interior of the lower portion 24 of the housing 22 may be securely divided. A first secure portion may contain the machine controller, bill acceptor/ticket reader and associated cashbox. Other portions may contain features such as the conveyor 134, elevator 136, etc. As indicated above, access to those portions may be controlled, including by different locks, and may include various security mechanisms such as intrusion sensors. As one example, access to a portion of the housing 22 that contains the controller may be via a door or panel having at least a first lock which can only be opened by first personnel, while access to the remaining portion of the housing 22 may be via one or more doors or panels having a second lock which can be opened by second personnel, such as for general servicing.

Aside from providing or positioning cameras so that they can capture aspects of game play, one or more cameras or other image capture devices might be utilized to capture other aspects of the operation and use of the gaming machine 20. For example, one or more cameras might be used to capture operation of the game object delivery mechanisms (e.g. conveyor 134, elevator 136, etc.) or other elements of the gaming machine 20, and/or be placed inside of the housing 22 to monitor access thereto (whether authorized or unauthorized). Images or video captured thereby may be used for game validation, security or other purposes. For example, in the event of a game malfunction, captured images might be used to determine an elevator or conveyor malfunction, etc. In some embodiments, the images or video may be accessed by an operator menu. This menu might be displayed on one of the displays 32, such as based upon input to the controller of the gaming machine 20 by authorized personnel, or might be transmitted to a remote server or the like for storage and viewing, independent of the gaming machine 20.

In one configuration, the controller or sub-controllers associated therewith may be configured to detect each sensor, counter, etc., wherein if one or more of the sensors, counters or the like are not detected, the controller may stop the game. As one example, a sensor might be provided which detects the number of play objects 120 which are launched by the launcher 130. If that sensor failed, play objects 120 might continue to be launched without the knowledge of the controller, causing a mis-play of the game (for example, a malfunction that resulted in high payouts to the player).

In one embodiment, the gaming machine 20 may be configured to resolve malfunctions or errors - e.g. automatically trigger certain corrective actions or events in the case of a malfunction or error. For example, the gaming machine 20 may include means for moving, such as vibrating, one or more of the elements of the gaming machine 20 (such as the collection area 106, conveyor 134, elevator 136, main and/or secondary play surfaces 100,102, etc.), such as to clear jams of game objects. For example, a camera or other sensor might be used to detect that the collection area 106 is clogged. This may cause the controller of the gaming machine 20 to trigger a vibrator which vibrates the collection area 106. As another example, an award for a prize object might be triggered when, although the prize object was not initially detected by a sensor S associated with the collection area, a secondary sensor, such as a camera C or the like, confirmed that the prize object was collected.

In some embodiments, the operator of the gaming machine 20 might elect to manually trigger certain events or manually reflect their occurrence. As one example, a player might cause a prize object to fall into the collection area, where that prize object is not registered by one of the sensors S or readers R. The operator might access, such as using an appropriate login (which may also require secondary or supervisory approval) a menu which allows the operator to manually award the prize object and thus trigger any associated award/feature, etc. For example, the prize object might have an associated award of 50 play objects that the player can launch. The operator might manually award that prize object, causing the controller to award the associated 50 play objects. In some embodiments, the gaming machine 20 may include an artificial intelligence (AI) engine. The controller of the gaming machine 20 may provide information to the AI engine which is used by the engine to analyze operation of the object game, such as to detect errors and to determine actions to be taken to correct such.

In some instances, the operator might use secondary information to validate the player’s claim. For example, although a sensor or reader may not have detected the collection of the prize object, as described herein, one or more image capture devices C might capture passage of the prize object into the collection area 106, its movement along the conveyor 134 or the like. The operator might view the one or more images to visually confirm the player’s claim.

As another example, the gaming machine 20 might negate a win (such where a prize object was moved to the collection area) due to tilt sensors triggering a tilt mode. The operator might validate the tilt condition, such as by accessing one or more menus and viewing information regarding the tilt trigger. The operator might determine, for example, that the tilt condition was not triggered by the player. In such event, the operator might again manually award the prize associated with the prize object.

### Games and Promotional Events

As indicated above, one or more games or promotional events may be presented relative to the play area 34, wherein in one embodiment, the games or events utilize game objects. In a preferred embodiment, game objects are associated with one or more play surfaces and an object of the game is to move game objects from the play surfaces to one or more collection areas.

In some embodiments, play of the object game may be triggered by or result from play of the main game, such as a wagering game. For example, play of a wager-based bingo main game may trigger play of the object game, such as due to a particular bingo game outcome, an event occurring during play of the main game (such as other than a game outcome) or the like. Play of the object game might also be awarded separate from play of the main game, such as on a promotional basis. Also, while play of the object game may result in one or more direct outcomes, play of the object game might itself trigger or result in play of the main game (such as an award of a play of the main game). In this regard, control of the main game and object game may be intertwined.

In one configuration, a set of game objects (play objects 120 and game objects 122) are pre-associated with the play surfaces before the first play of the game (for example, by achieving an object game equilibrium state, as described in more detail below). In some embodiments, the play surfaces might be entirely cleared and reset before each player plays the game (again, where the play surfaces are cleared and a new equilibrium is achieved). In a preferred embodiment, however, once the gaming machine is put into service, each player plays the game in the play area 34 based upon the status of the game from the last player (unless the gaming machine needs to be serviced/reset etc.). This adds excitement to the game. For example, once a number of game objects are associated with the play surfaces, and potentially in positions where they are likely to move to the collection area 106, a player may not wish to leave the machine -knowing that the next player will inherit the machine in that configuration and potentially receive a substantial win.

As indicated above, the main game may comprise any number of games. Aside from bingo games, slot, video poker or other games, a main or base game might itself comprise a skill or amusement game. Further, the gaming machine 20 might include or be linked to one or more tertiary games. As one example, aside from a main game such as a wagering slot, video poker or bingo game and a first object game such as disclosed herein, the gaming machine 20 might include a secondary object game or other secondary amusement and/or skill game. As one example, the gaming machine 20 might include a secondary Pachinko game. This game may be implemented by a Pachinko game unit which is associated with the gaming machine 20, such as by being connected to or supported by the housing 22. As one example, play of the object game herein might trigger a play of these secondary games, such as the Pachinko game. For example, collection of game objects (a certain number of play objects, certain prize objects or the like), might award Pachinko balls which the player can play in the Pachinko game. Play of this additional game might yield monetary or non-monetary awards, free main game play, triggers of the play or features of the object game, etc.

In some embodiments as described herein, play of the object game may result in the award of game credits which may be used to play instances of the main game or the triggering of features relating to the main game. In other embodiment, however, play of the object game may result in awards of the play of other main games (other than the one that triggered the play of the object game, for example). As one example, a player might play a first bingo main game, where that first bingo game has a first set of winning outcomes and associated awards. As a result of the play of that game, the player might enter play of the object game. The play of the object game might result in the award of the play of a second bingo game (such as by collecting a certain prize object). The second bingo game might comprise a main game which has a different set of winning outcomes (including guaranteed wins) and/or awards than the first bingo game. Such a feature is described in more detail in USPN 11,037,406 to the Applicant of this application, which patent is incorporated by reference herein in its entirety.

In other embodiments, it is possible for the object game to be triggered or enabled for play separate from main game outcomes. For example, play of the object game might be enabled by a remote player tracking or other server. For example, a player might earn a promotional award that allows them to play just the object game (e.g. independent of the main game).

### Award and Play of Play Objects

In one configuration of the object game, at one or more times a player is awarded play objects 120 to dispense on the playfield (such as via an object launcher, such as the launcher 130). The award of play objects to the player might be based upon one or more of a random outcome, such as from an RNG, or a defined game outcome trigger (of the main game or the object game). The one or more triggers or the like may or may not be disclosed to the player. As one example, a particular triggering event in the main game (such as the appearance of a particular slot game symbol or combination thereof, a bingo pattern match in a bingo game, a playing card or hand, etc.) may trigger the award of play objects to the player. As another example, the collection of a prize object may result in the award of play object to the player.

In some embodiments, the player may control the dispensing of awarded play objects, such as with one or more inputs to the gaming machine 20 (such as pulling a trigger, pushing a button, etc.). In some embodiments, the launcher 130 may be directionally controlled, thus allowing the player to control the direction of launching, such as to one side, the middle or another side of the raised play area 102. In another embodiment, the player is given the option to delay the dispensing and initiate it at their discretion at a later time.

In another embodiment, awarded play objects 120 are dispensed without player control, such as en masse automatically (the player does not actuate the individual dispensing). The automatic dispensing of play objects might result from a particular main game outcome or trigger, the collection of a prize object in the object game, or based upon other criteria. In one embodiment, the player is provided a countdown timer prior to the automatic dispensing. In another embodiment, dispensing begins immediately after the play objects 120 are awarded.

In a preferred embodiment, 100% of the play objects 120 are automatically dispensed. In another embodiment, some portion less than 100% of the play objects 120 are automatically dispensed and the remainder are reserved for the player to dispense at their discretion at a later time, either en masse automatically or one at a time. In such a configuration, the player may still be allowed directional control over the launching, while in others, the player may not control the direction of the dispenser during the automatic dispensing.

In another embodiment, the player may set the direction of the launcher prior to automatic dispensing, but once dispensing has initiated, the player may not change the direction of the launcher. In another embodiment, the launcher direction changes in a pre-set pattern during the launching. In another embodiment, the launcher direction changes randomly during the dispensing.

In another embodiment, the launcher direction changes in a pre-set pattern during the launching, but the player can force a direction change at any time with the press of a button, etc.

In a preferred embodiment, the rate at which play objects 120 automatically launch changes dynamically over time until the final play object is launched or dispensed. In one embodiment, that rate increases. In another embodiment, that rate decreases. In another embodiment, that rate both increases and decreases based on pre-defined criteria which may include but is not limited to: the number of play objects 120 launched, the number and/or nature of the play objects 120 removed from the main play surface 100 during the automatic launching, elapsed time. In another embodiment, the player can control the rate. In a preferred embodiment, the rate increases based on the number of play objects 120 launched. In another embodiment, the rate increases based on criteria correlated with the number and nature of the play objects 120 removed from the main play surface 100 during the automatic launching.

In another embodiment, the play objects 120 are only launched when the object mover (such as the movable raised playing surface 102) is in an optimal position for maximum effect.

There may exist special prize objects that enhance the automatic launching process when collected during the automatic launching. That enhancement could be the awarding of more play objects 120. In another embodiment, that enhancement could be a rate change to the current automatic launching rate of play objects 120.

In some embodiments, play objects 120 might be awarded as a promotion. A player might be provided with a ticket, player tracking award or the like which they can redeem at the gaming machine 20 to receive play objects 120 which may be dispensed in the manners described above.

In other embodiments, a player might purchase play objects 120 or they might be obtained based upon wagers made in the base game. For example, a player might pay to obtain additional play objects 120.

In one embodiment, the launching or other dispensing of prize objects 122 onto the one or more play surfaces is controlled, and separate from the play objects 120. In one embodiment, prize objects 122 are dispensed only by the controller and the dispensing thereof may be based upon a variety of factors. In one configuration, it is desired that a certain number of prize objects 122 be associated with the play surface(s) at all times (thus causing a sufficient number of prize objects to be “in play” that it entices the player to play). This number might be 50-90 or more preferably 70-90 objects, but may vary depending upon the size of the play surfaces, size of the objects, etc.

In one embodiment, the number and/or timing of the dispensing of prize objects 122 might be controlled, including being randomized (such as to prevent a player from knowing when they will be released and attempting to release play objects 120 in a manner which maximizes the effect thereof). In one configuration, prize objects 120 are only launched or dispensed during play of an object game (and not when the game is not being played). In general, one aspect of the invention is limiting player control over the launching or other placement of game objects.

In one configuration, the gaming machine 20 may be configured to pool or collect game objects, and particularly play objects. In one embodiment, the play objects might be physically pooled. For example, the gaming machine 20 might be configured to pool play objects at the bottom of the collection area 106 or in a separate area (such as in association with the launcher 130).

In another embodiment, game objects, such as play objects, might be virtually pooled. For example, based upon a number of collected play objects, a player might be awarded one or more play objects to be dispensed onto the play field(s). As one example, for every 5 or 10 collected play objects, the player might be awarded one or more play objects.

In this regard, the play objects might be pooled or collected (physically or virtually) at one or more rates and in one or more quantities. For example, play objects might be pooled at a rate which correlates to the number of play objects which are collected.

The play objects might be pooled in response to a triggering event (in the main game or the object game, such as the collection of a particular prize object).

The pooled play objects might be dispensed at various times and in various manners, such as described above. For example, the pooled play objects might be dispensed to the main and/or secondary play surface automatically, such as in response to a triggering event -whether in the main game or in the object game, including as a result of the collection of a prize object, etc., or by the player). Alternatively, the play objects might be dispensed by the player, at their discretion or at certain time. In some embodiments, the pooled play objects may be provided to the player (e.g. made available for launching/dispensing) on a random basis (whether triggered in the main game or the object game), due to certain triggering events (such as receipt of a particular main game outcome or other trigger, receipt of a particular prize objects or other object game outcome or event). In some embodiments, all pooled play objects might be made available for dispensing/launching, while in others only a portion of the pooled play objects might be made available.

### Object Game Outcomes

In a preferred embodiment, that outcome is directly related to an accrued number of game objects successfully removed from the playfield. In some examples, prizes or awards are only associated with prize objects and thus only awarded for collected prize objects. In other examples, one or more award or prizes might be provided for the collection of play objects. Where the play objects do not have particular prizes associated therewith, the collection of a certain number of play objects might result in an award. As one example, a player might collect a prize object bearing a $, which is associated with a $5 award. The player might also collect 50 play objects. Those objects might yield an award of $1, or might simply yield the player the ability to play another 20 play objects (thus increasing the probability of collecting another prize object).

In one embodiment, prizes are “accrued”, instead of being awarded immediately. For example, a player may move a number of prize objects 122 to the collection area 106. The associated prizes may be stored or collected, where the player then redeems those awards at a later time. As one example, prize objects 122 might represent a free play of the main game. The player collects them and accrues them in a pending “free game” meter. In a preferred embodiment, they are redeemed when the player obtains a special “Free Games” prize object 122. In other embodiments, they might also be redeemed when the player achieves a specific outcome on the associated main game, or based on a random paid game once a pre-defined threshold of free games have been accrued.

In another embodiment, that outcome is directly related to a specific special prize object or objects that are successfully removed from the playfield.

Game outcomes may result in the award of prizes, such as monetary value credits that are associated with the player’s credit balance, or other awards. For example, in some variations, a player might win tangible prizes which are awarded directly or via a different prize redemption or dispensing mechanism. Some prizes might comprise all or a portion of a jackpot, including a progressive jackpot that increases over time.

In some examples, prize objects may have the same or might have different awards. In some embodiments, the awards may be dynamic, such as changing at one or more times. As one example, the awards which are associated with prize objects might vary depending upon the size of the player’s wager. In this regard, in cases where a player is provided with a promotional award of the ability to play a certain number of play objects or the like, the player may be required to present that promotional award to a gaming machine having a designated denomination.

In some examples, prize objects may be sponsored. For example, certain prize objects might have awards associated therewith which are sponsored - e.g. not paid out of the hold of wagers associated with the gaming machine. Such awards might be promotional. For example, a brewer might sponsor free beer prizes. Certain prize objects might be marked with the logo of the brewer and, if collected, might result in the dispensing of a ticket to the player that can be redeemed for a free beer.

In the configuration described above, game objects are recycled - moving from a collection area to the play surface(s) and then back to the collection area, etc. In some examples, game objects might be awarded to the player. For example, certain prize objects might be collectable, such as being special in nature (such as a made of silver, etc.). In some embodiments, those prize objects might be diverted from the collection area to a dispensing area where the player can take the won prize object. Of course, in such configurations, a replacement prize object is preferably introduced to the set of game objects being used to play the game so that the equilibrium of the game is not affected. In some embodiments, these special prize objects might be retained by the player or they might be redeemable, such as for currency, merchandise, etc.

In a configuration in which certain prize objects may be collected, one or more sorters may be provided for separating those prize objects from other prize objects and/or the play objects. That sorter may route the special prize objects to a delivery area for player pick-up. In other embodiments, when a prize object is collected, it may be routed back to the play surfaces, and a separate prize dispenser of the gaming machine 20 may be used to dispense the associated physical prize to the player. For example, a particular captured prize object might comprise a medallion. That prize object might be routed back for game play, while a separate medallion is dispensed from a prize vault in the gaming machine 20 to the player. Further, a separate object launcher may be provided for introducing such special prize objects onto the one or more play surfaces.

As noted above, in some embodiments the gaming machine 20 may have different collection areas 106. In this configuration, different sensors may be associated with each collection area in order to detect/sense game objects which are collected in each of those areas. Also, means must be provided for moving game objects from those different collection areas to the main and/or secondary play surface, such as by common or separate conveyors, elevators and the like.

In some embodiments, collection of game objects in different collection areas 106a,b,c might generate different outcomes. For example, during a certain period of time, collection of game objects into a center collection area 106b might result in a 2X payout (such as relative to collected prize objects having a monetary value) as compared to collection of the same object in the other collection areas. As another example, collection of combinations of game objects (such as particular prize objects) in combinations of the collection areas 106a,b,c might result in a particular winning outcome and associated award.

### Alternate Game Features

In some embodiments, the game objects may be associated with playing card indicia. For example, game objects may be uniquely identified (such as by RFID tags or otherwise, as detailed above), where the objects are associated with playing card values (rank/suit). The object of the game may be to collect game objects which generate particular hands or outcomes (poker hands, blackjack hands, etc.). Certain hands or combinations of cards, etc., may result in the award of winnings/prizes.

In some embodiments, the game objects (the play and/or prize objects) may be associated with numbers or other indicia (similar to keno or bingo balls) where the player attempts to match those numbers to preselected numbers (by player or otherwise, including associated with a card or otherwise). A player might be awarded winnings for receiving certain numbers of matches, matching certain patterns, etc.

In yet other embodiments, a player might attempt to capture a specific set or combination of prize element to trigger an award, a larger award, or a game feature (such as launching of a number of play objects 120). For example, prize objects 122 might have different colors, numbers or the like, where if a player collects one of each colored prize object, or other combination of prize objects, that may comprise a trigger which causes the controller of the gaming machine 20 to award a prize or implement a feature, etc.

In certain configurations, the spots (locations/numbers) may be chosen at least in part by knowledge of where game objects are on the playing surface(s). The game feature might reset after the collection of certain numbers of game objects, such as 20 game objects or after each prize is awarded or a game-ending pattern or match is received. Game patterns might be mapped to different prize levels. Associated values (card indicia, bingo-keno numbers, etc.) might not be revealed to a player until the objects are redeemed (not merely collected in the collection area).

Game objects, such a prize objects 122, might serve as game board tokens. For example, different prize objects might designate the movement of a token or tokens on a depiction of a board game. The movements might vary (1 space forward, 5 backward, etc.) or have other characteristics (movement of a specific board token, more than one token; can have multiple “movement points” represented; can have “instant move to specific location” represented). Successful movement of a game board token to a particular position, end point or the like might be associated with a prize or other event).

In some embodiments where the introduction of game objects is controlled (such as by controlling the dispensing of prize objects 122), the introduction of certain game objects may be controlled based upon criteria. For example, a game winning game object might only be dropped or introduced onto the play surface(s) at certain times (this allows the game to be in an almost perpetual state of being “one away” from the top prize).

In some embodiments, a game object may be “hot” or have a special status. For example, collection of a “hot” prize object may result in the award of a special prize or might result in a multiplier effect or the like. The “hot” object might vibrate, buzz/light when a special prize is available, etc. In some embodiment, an image of the “hot” object might be displayed to the player on one of the video displays 32a,b,c when it is in play or when a special prize associated therewith is available. The player might also be presented with information regarding when the “hot” object will expire (enticing the player to try and move the object to the collection area as fast as possible), a graphic depiction of the special prize, information regarding a winning machine, etc. Of course, multiple “hot” objects might be activated or utilized. In some cases, all game objects (or at least prize objects) might be designated or activated to comprise hot objects - such as during a period of time (such as shown on a countdown clock to the player, etc.), until a certain number of game objects (or play objects) are moved to the collection area, etc.

In some embodiments, game objects might be associated with puzzle pieces, where a player attempts to collect game objects that then cause the collection of puzzle pieces - such as where a player attempts to complete the puzzle. Some game objects might represent the same puzzle piece, thus requiring the player to continue to collect objects to obtain the “missing” pieces.

In another example, the game objects might be associated with symbols, such as slot symbols. The slot symbols might be collected and associated with reels which the player can then spin (or which spin when filled or spin when the player collects a spin-triggering object) to attempt to obtain a winning combination of symbols. Some objects might include multiplier values or the like.

As noted above, at various times, game objects might have different characteristics. In some cases, the objects might be different from one another. For example, certain prize objects might be one color and others might be a different color, certain prize object might be printed with or bear first information (monetary value, prize information, etc.) and others might bear second information, etc. In one configuration, the game objects (or at least the prize objects) might include means for changing one or more characteristics thereof. For example, one or more of the prize object might include a display (such as an LED, OLED or other display), a controller, a power source (such as a battery), and a receiver. These prize objects may be configured to display information on the display thereof. For example, the displays thereof might display puzzle piece pictures, prize amounts or other awards. As another example, the displays might display advertising, merchandise information or avatars. In some embodiments, the information which is displayed by the display of the prize object may be linked to other aspects of the gaming machine 20, including other game features. For example, as noted above, during a “hot” period, the displays of the prize objects might turn red. The displays might also display slot symbols, puzzle piece symbols or the like. In one configuration, one or more of the displays of the prize objects might display an avatar. This avatar might interact with the main game, such as by appearing on one or more of the displays 32, including during a main game. For example, if a player collects a prize object bearing an avatar, the controller might cause the avatar to be displayed on one of the displays 32, such as part of a game, including by interacting with the same (causing a spinning of reels, daubing a bingo card, revealing a multiplier, awarding an award, etc.). In this embodiment, the controller of the gaming machine 20 may send wireless signals to the one or more prize objects to cause them to display the desired information/images, etc.

The game may include bonus modes or the like. For example, similar to a “hot” mode, at certain times, during certain time windows or the like certain game objects might have an enhanced state where collection of the object triggers a feature. For example, a prize object might trigger the award of 50 playable play objects. At certain times, the collection of that prize object might trigger the award of 100 playable play objects. As another example, a prize object might, when collected, result in a 2X multiplier for all awards during a period of time thereafter. At certain time, collection of that prize object may result in a 4X multiplier for all awards during a period of time thereafter. As another example, when the base game is a bingo game, at certain times the collection of a prize object might cause the main game to present a different bingo game which offers different or higher awards.

In another embodiment, one or more game objects might be associated with merchandise prizes, such as might be collected at a prize booth, prize redemption devices or the like. The collection of a game object having an associated merchandise award might result in the dispensing of a prize ticket which the player uses to collect/redeem the prize. In some embodiments, a player might need to collect more than one object, such as represented by more than one ticket, to obtain certain prizes. In yet other configurations, collection of game objects can lead to a secondary game event that awards one of a plurality of prizes, one of which is the merchandise.

The object game may be part of a community or tournament game or event, such as involving other gaming machines 22 and associated players thereof, such as in a banked configuration. In such a configuration, a player might collect a particular object to enter the player into the event.

In one configuration, for example, players may attempt to collect as many play objects as possible during a period of time, a game session or the like. The players with the highest play object collection totals might be indicated on a leaderboard and/or be awarded prizes.

### Math

An important aspect of a regulated wagering game is the ability to reliably determine the actual payback percentage (the inverse of hold percentage) for N games, where N is the number of games necessary to determine the theoretical payback percentage with a certain confidence interval (such as 95%) within a range (such as +/- 5%). This thus requires the ability to determine, with reliability, the theoretical payback percentage. Of course, this can’t be determined reliably if the outcomes of the games can be manipulated by a player to a high degree or in the event outcomes of the game vary too much due to variations in the operation of the gaming machine itself. In this regard, another aspect of a regulated game is generally that the hardware of the game not provide an advantage or disadvantage to the player thereof.

In the case of an object game such as that described above, a hold percentage can only be determined if a playfield (play surface(s)) object equilibrium can be determined - meaning the expected (mean) number of game objects the playfield (play surface(s)) can hold before the addition of another single game object would result in at least one game object being forced to the collection area. The playfield is the collective play surfaces upon which all game objects may come to rest and ultimately be forced off into the collection area.

One “cycle” or session may be defined as the expected (mean) number of game objects required to be added to the play surface(s) in order to cycle all game objects associated with the gaming machine at least once through the collection area.

A variety of the features noted above may be utilized to impact the game object equilibrium. Among these include variation in game objects, play surfaces, object movers, and object launchers, as described above. As specific (but non-limiting examples):

1) Nature of each game object (shape, thickness, mass, size, texture, etc.)

2) The number of each different type of game object that will be introduced onto the play surface(s) (including how and where they are introduced), the number of game objects that can be introduced, the speed of introduction.

(3) For the average cycle session in order to cycle all game objects through into the collection area (“clear the playfield”), the ratio of: (a) the number of different objects to the total number of objects and/or (b) the number of times each unique type of object will cycle through the playfield.

(4) The ratio of the session each object is available for deployment on the play surface(s).

(5) The amount of play surface space available for game objects, including variance in that space, such as due to object movers (for example, movement of a raised play surface 102 increases and decreases the space of the main play surface 100 to hold game objects; a static distance of the back/forward distance will result in the raised play surface 102 space to be measured in the retracted position. If the back-and-forth distance is variable, then the ratio of the time each of the positions may be applicable.

(6) The slope angle of the main play surface 100 and/or any raised or secondary play surface 102 (and when variable, then the ration of the time in different positions may be applicable).

(7) The angle of the ledge 104 of the main play surface 100 (again, if variable, then the ratio of the time in each position may be appliable).

(8) The method by which a game object is introduced to the play surface(s), including: (a) if skill is involved, such as launching objects at a specific time and/or place on the top shelf of the play; (b) if game objects are randomly introduced; (c) whether game objects are introduced by a player with or without skill or in an automated fashion (with or without allowing the player to apply skill to location of placement) and/or manually introduced by player or casino personnel (lift lid of playfield, drop object down chute to enter playfield, etc.).

(9) All objects must be replaced or recycled - and where the speed at which they are re-introduced effects the equilibrium (for example, if they are introduced at a slower rate than they are being collected, the collection rate will fall and lag until equilibrium is re-established at a later time).

Once the “play” variables have been quantified, if the game has a skill elements, then a ‘perfect play’ strategy (the one that results in the maximization of the probability of game success) must be used for each of those skill elements to determine the desired payout of the game by knowing the number of objects needed to place onto the playfield in order to cycle all objects off the playfield. Only then can prize values associated with any object that creates a prize value directly (such as a prize object with a value or range of values) or indirectly (collecting a certain number of prize objects that fall into the collection area may give the player additional chances to collect a prize object) be set. Further, once prize values are set (such as by a paytable of awards), then steps must be taken to ensure that the game operates properly, as changes in game operation - such as due to changes it the features noted herein, will change the payout and thus the hold of the gaming machine 22 (and particularly the object game).

As one aspect of the invention, the various counters or readers R may be used to monitor the movement of the game objects in the play area 34. If, for example, a certain game object (such as a prize object 122) is not detected for a long time or is only detected by one sensor, it may be determined that the game is not operating correctly, that the prize object 122 is broken or damaged or the like. Further, the count and movement of the game objects may be used to determine if the game is operating correctly, including based upon the desired play characteristics. For example, based upon the configuration of the gaming machine 22 has having certain features and corresponding pay table therefor, it may be determined that, on average 1080 game objects will remain on the play surfaces. If, based upon counter and/or sensor data, the controller determines that on average only 950 objects are located on the play surfaces, then a malfunction may be noted (and the game may be stopped). For example, in this example, the reduced number of tokens associated with the play surfaces would indicate that one or more features are incorrectly configured and are allowing a greater than normal number of game objects to move off of the play surfaces based upon the number of game objects that are being introduced onto the play surfaces. A similar situation might exist if a larger than normal number of game objects are located on the play surfaces.

In one configuration, the game controller monitors the number of game objects required to be added to the play surface(s) in order to complete a cycle (as defined above). In a preferred embodiment, prize objects are given an abstract value which is tallied as they are collected. This allows a total prize value to be assigned to the cycle. Periodically, the actual number of game objects is compared to a target number of game objects required to be added to the play surface(s) in order to complete a cycle. In a preferred embodiment, this comparison occurs each time a defined fraction of the total value of collected prize objects in real time is attained.

In a preferred embodiment, the difference between the target number of game objects required to be added to the play surface(s) and the actual number of game objects required to be added to the field at the time the comparison occurs, is tallied and accrued to a pool. Accrued values can be positive or negative. Within defined parameters, when and if the actual number of game objects required to be added to the play surface(s) in order to complete a “cycle” is greater than the target, additional game objects will be added (during start-up, as detailed below, this may be by automatic release of the objects to the play surface(s) to achieve equilibrium, and during game play, this might be automatic or might be by granting the player the ability to launch them), resulting in the number of cycles per paid game approaching the number of cycles per paid game associated with the target number of game objects required to be added to the play surface(s) in order to complete a cycle.

In one embodiment of the invention, operation of the object game is not initiated until equilibrium is achieved. In order for the object game to operate the same for each player, including the first player, the configuration of the object game - including the arrangement of game objects on the main and/or second play surfaces, must essentially be random. If the operator were to manually place game objects on the main and/or play surfaces, it is highly unlikely that the placement of those objects would mirror the arrangement of those objects as a result of play of the game. In one embodiment, the object game may be run in a setup mode (such as where the game can’t be played by a player and a player is prevented from dispensing play objects) until all objects are cycled through the collection area a certain number of times (such as 2-3 times). In another configuration, the object game may be configured with a minimum and maximum cycle time (such as defined by launching play objects) and the object game cycles until it detects equilibrium has been reached or it has exceed the maximum cycle time (such as due to errors that prevent the game from reaching equilibrium - in which case an error may be noted to prevent the game from being placed into play mode by players until a technician corrects the machine). As such, in a preferred embodiment, when the object game is set up for play, it is run until, as indicated herein, equilibrium is detected.

In one embodiment, features may be changed or adjusted, such as based upon the location of the gaming machine 22 (such as on a slanted gaming floor) in order to achieve the desired equilibrium. For example, upon placing a gaming machine 22 in a particular location, a tilt in the floor might cause the game object equilibrium count to be 980 objects. As a result, the angle of the ledge 104 might be raised, thus reducing the flow of objects off of it, until the desired equilibrium of 1080 game objects is achieved. Alternatively, in such a situation the pay table might be adjusted, such as by providing lower payouts, etc., to offset the higher win frequency (due to a higher than average flow of game objects to the collection area).

### Alternate Embodiments and Other Features

In one embodiment, a player might play the gaming machine 20, such as the object game, remotely. Alternatively, the player of the gaming machine 20 might play another gaming machine remotely. As one example, a player playing the gaming machine 20 might receive a particular outcome as a result of collecting certain game objects. That outcome might allow the player to redeem the prize or play for a prize via another gaming machine, such as one described in U.S. Pat. No. 11,145,163 which is incorporated herein in its entirety herein by reference.

In one embodiment of the invention, object game wins might result in free game play of the main game. As one unique aspect of the invention, the gaming machine 20 and/or associated system transfers such free play awards to the credit meter of the gaming machine 20 for main game play. As one example, the object game may be associated with a promotional server which receives information regarding free play awards which are received by a player when playing the object game. The promotional system may communicate with a slot accounting system (SAS) port which is associated with the main controller of the gaming machine 22, which port is configured to receive instructions regarding one or more credits to be added to the credit meter of the gaming machine 20, which credits can be used to place wagers to play the main game.

As indicated above, a player might participate in a tournament type game by normal play of the gaming machine 20. However, in other embodiments, gaming machine 20, such as the object game, might be played in a tournament mode. In such a configuration, a player might be provided with a number of play objects 120 to launch during a period of time. The player may attempt to collect the most play objects and/or prize objects as a result of the play of those play objects. In a tournament game, the one or more players who collect the most play objects and/or prize objects might be declared to be the winners of the tournament. Tournament events might have leader boards (local, regional, national) with different associated prizes. In tournament mode, the player might be awarded “tournament objects”, or a tournament token reel pops up and awards tournament points per spin.

In one configuration, a player might buy a fixed number of main games (like place a $300 wager for 60 $5 game plays) and, based upon making such a large wager, be qualified to play a tournament object game (as a reward for the wager/purchase).

As another example, a player might qualify for a community game based upon a certain wager amount (fixed buy or over time). Qualification for the community game may entitle the player to participate in community awards associated with the play of other gaming machines by other players. As one example, 5 players might qualify for a community game in which a $1000 prize is awarded if the players collect 500 play objects within a designated period of time (collectively). If this community trigger is met, regardless of the number of play objects that the individual player collected, they would win a portion of the $1000 prize (such as $1000/5, or $200).

Aspects of the invention, including specific features, may be used in other environments, including with other types of gaming machines or devices. As one example, aspects or features of the invention might be applied to crane or claw type object games where objects are associated with a playfield or surface and a player attempts to move/remove those objects from the play surface.

Further, in some embodiments, gaming machine may comprise the object-based gaming device without the main/base wagering game, where the obj ect-based gaming device might be played with or without a wager or other payment. For example, aspects of the object-based game may be applied to amusement type object games, such as are often presented in non-casino environments.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a play surface on which a plurality of game objects are supported;
a game object mover configured to engage one or more of the plurality of game objects on the play surface, whereby one or more of the plurality of game objects may move over a ledge of the play surface and fall into a collection area;
at least one transport mechanism configured to move the game objects which fall into said collection area back to said play surface at one or more times.

2. The gaming machine in accordance with claim 1, wherein said game objects comprise a plurality of play objects and a plurality of prize objects, said play objects and said prize objects having at least one characteristic which differs from one another.

3. The gaming machine in accordance with claim 1, wherein said play objects comprise coins and said prize objects comprise tokens.

4. The gaming machine in accordance with claim 1, wherein said ledge is angularly positionable.

5. The gaming machine in accordance with claim 4, wherein said ledge has a front and a back, said back located adjacent to said play surface and wherein said front may be raised and lowered relative to said back.

6. The gaming machine in accordance with claim 1, wherein said game object mover is configured to reciprocate back and forth relative to said play surface.

7. The gaming machine in accordance with claim 1, wherein said play surface comprises a main play surface and a secondary play surface which is located above said main play surface.

8. The gaming machine in accordance with claim 7, wherein said game objects comprise a plurality of play objects and a plurality of prize objects and said at least one transport mechanism is configured to deliver said prize objects to said secondary play surface and deliver said play objects to said main play surface.

9. The gaming machine in accordance with claim 1, wherein said at least one transport mechanism comprises a game object launcher which is configured to launch game objects onto said play surface.

10. A gaming machine comprising:
a housing;
an movable object type amusement game device comprising:
a play surface on which a plurality of game objects are supported;
a game object mover configured to engage one or more of the plurality of game objects on the play surface, whereby one or more of the plurality of game objects may move over a ledge of the play surface and fall into a collection area; and
at least one transport mechanism configured to move the game objects which fall into said collection area back to said play surface at one or more times;
at least one display device;
a monetary-value receiving device for creating a monetary value credit balance at the gaming machine; and
a processor, said processor configured to execute machine-readable code stored in memory to:
present at least one wagering game to said player in response to a wager placed from said monetary value credit balance, comprising presenting wagering game information on said display device;
determine an outcome of said wagering game and award winnings for winning outcomes of said wagering game; and
activate said amusement game device for play by said player one or more times.

11. The gaming machine in accordance with claim 10, wherein said at least one transport mechanism comprises a movable game object launcher for directing game objects onto said play surface and play by said player comprises providing player input to move said launcher.

12. The gaming machine in accordance with claim 10, wherein said at least one wagering game comprises a wager-based bingo game.

13. The gaming machine in accordance with claim 10, wherein said game objects comprise a plurality of play objects and a plurality of prize objects, and wherein said gaming machine is configured to award an award for movement of a prize object into said collection area.

14. The gaming machine in accordance with claim 13, further comprising a prize dispenser, wherein said processor is configured to activate said prize dispenser to dispense said award.

15. The gaming machine in accordance with claim 10, wherein said processor is configured to activate said amusement game device in response to a triggering event occurring during the play of said at least one wagering game.

16. The gaming machine in accordance with claim 10, further comprising at least one sensor for sensing the game objects that fall into said collection area.

17. The gaming machine in accordance with claim 10, wherein said play surface is located in a play area and a plurality of image capture devices are located in said play area.

18. The gaming machine in accordance with claim 17, wherein at least a portion of a top of said play area is transparent to allow viewing of said play surface there below.

19. The gaming machine in accordance with claim 10, wherein said game object mover is configured to move towards and away from said front of said housing relative to said play surface.

20. The gaming machine in accordance with claim 10, wherein said housing has a front and rear, said display device faces said front, said play surface has a front and a rear, said ledge is located at said front of said play surface and said collection area is located at a front of said ledge at said front of said housing.
